(19) United States
(12) Patent Application Publication
(10) Pub. No.: US 2023/0368231 A1
(43) Pub. Date: Nov. 16, 2023

(54) DATA MANAGEMENT METHOD, TERMINAL, AND RECORDING MEDIUM

(71) Applicant: Panasonic Intellectual Property Corporation of America, Torrance, CA (US)

(72) Inventors: Junichiro SOEDA, Nara (JP); Motoji OHMORI, Osaka (JP); Kakuya YAMAMOTO, Hyogo (JP); Junji MICHIYAMA, Fukuoka (JP)

(21) Appl. No.: 18/225,290

(22) Filed: Jul. 24, 2023

Related U.S. Application Data
(63) Continuation of application No. PCT/JP2022/001775, filed on Jan. 19, 2022.
(60) Provisional application No. 63/142,611, filed on Jan. 28, 2021.

(51) Int. Cl. G06Q 30/0201; G06Q 40/04; G06Q 20/38

(52) U.S. Cl. CPC G06Q 30/0206; G06Q 20/389; G06Q 40/04

(57) ABSTRACT

In a data management method, a plurality of servers store, in a distributed ledger, at least one instance of transaction data each including record information; the record information includes a record of at least one data set; and each data set includes at least one instance of data, among a plurality of instances of data generated by a plurality of devices, satisfying a condition corresponding to the data set. The data management method includes a first terminal owned by a first user of a target data set, or a second terminal owned by a second user of the target data set, performing the following: obtaining the record of at least one similar data set similar to the target data set from the record information; and determining a value of the target data set based on the record obtained.

### CROSS REFERENCE TO RELATED APPLICATIONS

This is a continuation application of PCT International Application No. PCT/JP2022/001775 filed on Jan. 19, 2022, designating the United States of America, which is based on and claims priority of U.S. Provisional Pat. Application No. 63/142611 filed on Jan. 28, 2021. The entire disclosures of the above-identified applications, including the specifications, drawings and claims are incorporated herein by reference in their entirety.

### FIELD

The present disclosure relates to a data management method, a terminal, and a recording medium.

### BACKGROUND

PTL 1 discloses a technique in which information (data) is collected from various IoT devices using a distributed file sharing technique in which electronic file information such as HTML, PDF, and text are shared, after which the information is autonomously implemented as a web service and shared over a distributed file sharing network formed by IoT gateways.

### CITATION LIST

### Patent Literature

PTL 1: Japanese Unexamined Patent Application Publication No. 2019-79577

### SUMMARY

### Technical Problem

However, the method disclosed in PTL 1 does not take into account the value of data, and it is therefore difficult to determine an appropriate value efficiently.

Having been achieved in light of the foregoing situation, an object of the present disclosure is to provide a data management method, a terminal, and a recording medium capable of efficiently determining an appropriate trading price.

### Solution to Problem

A data management method according to one aspect of the present disclosure is a data management method using a management system that includes a plurality of servers holding a distributed ledger. The plurality of servers store, in the distributed ledger, at least one instance of transaction data each including record information. Each of at least one instance of the record information included in a corresponding one of the at least one instance of transaction data includes a record of a data set, indicated by the record information. Each of at least one data set corresponding to one of the at least one instance of record information includes at least one instance of data, among a plurality of instances of data generated by a plurality of devices, that satisfies a condition corresponding to the data set. The data management method includes performing the following, by one terminal among a first terminal owned by a first user of a target data set, among the at least one data set, and a second terminal owned by a second user of the target data set: obtaining, from the at least one instance of record information stored in the distributed ledger, a record of at least one similar data set similar to the target data set; and determining a value of the target data set based on the record of the at least one similar data set obtained.

A terminal according to one aspect of the present disclosure is a terminal communicably connected over a network to a management system including a plurality of servers holding a distributed ledger. The plurality of servers store, in the distributed ledger, at least one instance of transaction data each including record information. Each of at least one instance of the record information included in a corresponding one of the at least one instance of transaction data includes a record of a data set, indicated by the record information. Each of at least one data set corresponding to one of the at least one instance of record information includes a plurality of instances of first data, among a plurality of instances of data generated by a plurality of devices, that satisfy a first condition corresponding to the data set. The terminal is one terminal among a first terminal owned by a first of a target data set, among the at least one data set, and a second terminal owned by a second user of the target data set, and includes: an obtainer that obtains, from the at least one instance of record information stored in the distributed ledger, a record of at least one similar data set similar to the target data set; and a determiner that determines a value of the target data set based on the record of the at least one similar data set obtained.

Note that these comprehensive or specific aspects may be realized by a system, a method, an integrated circuit, a computer program, or a computer-readable recording medium such as a CD-ROM, or may be implemented by any desired combination of systems, methods, integrated circuits, computer programs, and recording media.

### Advantageous Effects

According to the data management method and the like of the present disclosure, an appropriate value can be determined efficiently.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of the configuration of a management system according to an embodiment.

FIG. 2 is a diagram illustrating an example of the configuration of a seller terminal according to the embodiment.

FIG. 3 is a table showing relationships between a number of trades of a similar data set and a first increase/decrease amount in a trading price, in a predetermined period.

FIG. 4 is a table showing relationships between fluctuations in a number of trades per unit of time of a similar data set and a second increase/decrease amount in a trading price.

FIG. 5 is a diagram illustrating an example of a UI for inquiring with a seller as to whether the seller is willing to trade at the trading price of a target data set.

FIG. 6 is a diagram illustrating an example of a UI for inquiring with a seller as to whether the seller is willing to trade the target data set at a desired purchase price.

FIG. 7 is a diagram illustrating an example of a UI for negotiating a price with a buyer.

FIG. 8 is a table showing an example of first trading record information.

FIG. 9 is a diagram illustrating an example of the configuration of a buyer terminal according to an embodiment.

FIG. 10 is a diagram illustrating an example of a UI for inquiring with a buyer as to whether the buyer is willing to trade at the trading price of a target data set.

FIG. 11 is a diagram illustrating an example of the UI that inquires with a buyer as to whether the buyer is willing to trade a target data set at a desired selling price.

FIG. 12 is a diagram illustrating an example of a UI for negotiating a price with a seller.

FIG. 13 is a table showing an example of second trading record information.

FIG. 14 is a diagram illustrating an example of the configuration of a management server according to the embodiment.

FIG. 15 is a flowchart illustrating an example of operations for storing trade record information in a distributed ledger, performed by the management system according to the embodiment.

FIG. 16 is a flowchart illustrating an example of operations for executing a trade, performed by the management system according to the embodiment.

### DESCRIPTION OF EMBODIMENTS

A data management method according to one aspect of the present disclosure is a data management method using a management system that includes a plurality of servers holding a distributed ledger. The plurality of servers store, in the distributed ledger, at least one instance of transaction data each including record information. Each of at least one instance of the record information included in a corresponding one of the at least one instance of transaction data includes a record of a data set, indicated by the record information. Each of at least one data set corresponding to one of the at least one instance of record information includes at least one instance of data, among a plurality of instances of data generated by a plurality of devices, that satisfies a condition corresponding to the data set. The data management method includes performing the following, by one terminal among a first terminal owned by a first user of a target data set, among the at least one data set, and a second terminal owned by a second user of the target data set: obtaining, from the at least one instance of record information stored in the distributed ledger, a record of at least one similar data set similar to the target data set; and determining a value of the target data set based on the record of the at least one similar data set obtained.

Through this, the value of the target data set is determined based on the record information stored in the distributed ledger of the plurality of servers, and thus the value can be determined based on record information which cannot be tampered with and which is publicized and transparent. This makes it possible to determine an appropriate price for the value of the target data set.

Furthermore, determining the value of the target data set based on a record established in the past provides an advantage in that it is easy to determine an appropriate value according to the market price of the target data set. However, generally speaking, a target data set subject to trade includes a plurality of instances of data, and may have a variety of combinations according to conditions. It is therefore unlikely that a data set specified by exactly the same condition as the first condition for specifying the target data set has been traded in the past. Accordingly, the value of the target data set is determined based on the record of at least one similar data set similar to the target data set, which makes it easy to determine an appropriate value according to the market price of the target data set even when there is no data set specified by exactly the same condition as the first condition for specifying the target data set.

Additionally, the value of the target data set is determined based on the record included in the distributed ledger of the plurality of servers, and thus even if communication is not possible with one server, the value can be determined by obtaining the record from another server. In other words, even if one server has malfunctioned, the communication path with one server has failed, or the like, and the record cannot be obtained from that one server, the record can be obtained from another server, which makes it possible to reduce the likelihood that the record cannot be obtained and the value cannot be determined. Accordingly, the retransmission of requests to the one server caused by the communication failure can be reduced, the processing load or the communication load until the record is obtained can be reduced, and the time required to obtain the record can be reduced as well. This makes it possible to reduce the power required to be consumed to obtain a single record.

Additionally, a plurality of instances of target data included in the target data set may be specified from the plurality of instances of data using a first condition; each of the at least one similar data set may include a plurality of instances of second data that satisfy a second condition, among the plurality of instances of data; and the second condition may be similar to the first condition.

Additionally, the one terminal may generate the transaction data including the record information that includes the record of the target data set, after a trade of the target data set is established; the one terminal may transmit the transaction data to at least one of the plurality of servers; and the transaction data received by the at least one of the plurality of servers may be stored in the distributed ledger by the plurality of servers executing a consensus algorithm.

Through this, transaction data including newly-generated record information is stored in the distributed ledger, and thus the record information can be stored in the distributed ledger as record information for determining the value of the target data set, which cannot be tampered with and which is publicized and transparent.

Additionally, the determining may include determining the value of the target data set based on the value of one similar data set among the at least one similar data set.

Through this, the value of the target data set is determined based on the value of one similar data set estimated to be close to the market price of the target data set, and thus an appropriate value can be determined according to the market price of the target data set.

Additionally, the one similar data set may be a newest similar data set among the at least one similar data set.

Through this, the value of the target data set is determined based on the value of the newest similar data set estimated to be close to the market price of the target data set, and thus an appropriate value can be determined according to the market price of the target data set.

Additionally, the determining may include setting the value price of the target data set higher as a total number of the at least one similar data set increases.

The demand for the target data set is estimated to be greater as the number of the at least one similar data set estimated to be close to the market price of the target data set increases, and thus the value can be determined according to the demand.

Additionally, the determining may include setting a higher value for the value of the target data set as a number by which the at least one similar data set increases per unit of time increases.

The demand for the target data set is estimated to be greater as the number of the at least one similar data set estimated to be close to the market price of the target data set increases, and thus the value can be determined according to the demand.

Additionally, the determining may further include: determining a first value range for determining the value of the target data set, the first value range being acceptable to an owner of the one terminal; obtaining a second value range for determining the value of the target data set from an other terminal among the first terminal and the second terminal, the second value range being acceptable to an owner of the other terminal; specifying an overlapping value range where the first value range and the second value range overlap; and determining a value included in the overlapping value range as the value of the target data set.

Accordingly, a value that is acceptable to both the first user and the second user can easily be determined as the value of the target data set.

Additionally, the determining of the value may include determining a median value of the overlapping value range as the value of the target data set.

A terminal according to one aspect of the present disclosure is a terminal communicably connected over a network to a management system including a plurality of servers holding a distributed ledger. The plurality of servers store, in the distributed ledger, at least one instance of transaction data each including record information. Each of at least one instance of the record information included in a corresponding one of the at least one instance of transaction data includes a record of a data set, indicated by the record information. Each of at least one data set corresponding to one of the at least one instance of record information includes a plurality of instances of first data, among a plurality of instances of data generated by a plurality of devices, that satisfy a first condition corresponding to the data set. The terminal is one terminal among a first terminal owned by a first of a target data set, among the at least one data set, and a second terminal owned by a second user of the target data set, and includes: an obtainer that obtains, from the at least one instance of record information stored in the distributed ledger, a record of at least one similar data set similar to the target data set; and a determiner that determines a value of the target data set based on the record of the at least one similar data set obtained.

Through this, the terminal determines the value of the target data set based on the record information stored in the distributed ledger of the plurality of servers, and thus the value can be determined based on record information which cannot be tampered with and which is publicized and transparent. This makes it possible to determine an appropriate price for the value of the target data set.

Furthermore, determining the value of the target data set based on a record established in the past provides an advantage in that it is easy to determine an appropriate value according to the market price of the target data set. However, generally speaking, a target data set subject to trade includes a plurality of instances of data, and may have a variety of combinations according to conditions. It is therefore unlikely that a data set specified by exactly the same condition as the first condition for specifying the target data set has been traded in the past. Accordingly, the value of the target data set is determined based on the record of at least one similar data set similar to the target data set, which makes it easy to determine an appropriate value according to the market price of the target data set even when there is no data set specified by exactly the same condition as the first condition for specifying the target data set.

Additionally, the terminal determines the value of the target data set based on the record included in the distributed ledger of the plurality of servers, and thus even if communication is not possible with one server, the value can be determined by obtaining the record from another server. In other words, even if one server has malfunctioned, the communication path with one server has failed, or the like, and the record cannot be obtained from that one server, the record can be obtained from another server, which makes it possible to reduce the likelihood that the record cannot be obtained and the value cannot be determined. Accordingly, the retransmission of requests to the one server caused by the communication failure can be reduced, the processing load or the communication load until the record is obtained can be reduced, and the time required to obtain the record can be reduced as well. This makes it possible to reduce the power required to be consumed to obtain a single record.

Note that these comprehensive or specific aspects may be realized by a system, a method, an integrated circuit, a computer program, or a computer-readable recording medium such as a CD-ROM, or may be implemented by any desired combination of systems, methods, integrated circuits, computer programs, and recording media.

Embodiments will be described hereinafter with reference to the drawings. Note that the following embodiments describe specific examples of the present disclosure. In other words, the numerical values, shapes, materials, constituent elements, arrangements and connection states of constituent elements, steps, orders of steps, and the like in the following embodiments are merely examples, and are not intended to limit the present disclosure. Additionally, of the constituent elements in the following embodiments, constituent elements not denoted in the independent claims indicating the broadest interpretation are not absolutely necessary for solving the problem of the present disclosure, and will instead be described as constituent elements constituting more preferred forms.

### Embodiment

The configuration of a system according to the present disclosure will be described first.

The configuration and the like of a management system according to the present embodiment will be described hereinafter with reference to the drawings.

### Management System

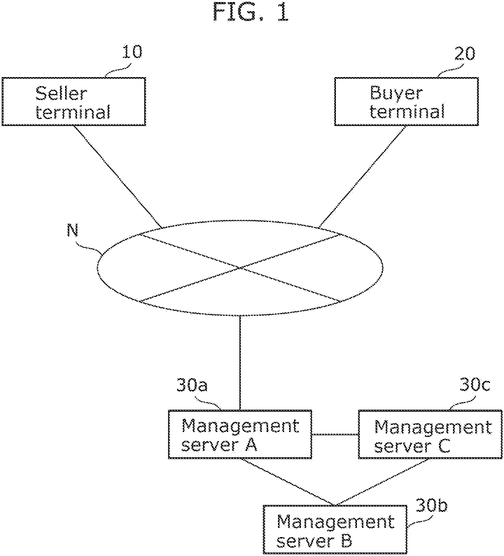

FIG. 1 is a diagram illustrating an example of the configuration of the management system according to the embodiment.

As illustrated in FIG. 1, the management system according to the present embodiment includes, for example, seller terminal 10, buyer terminal 20, and management servers 30a to 30c. These are connected over network N. Network N is, for example, the Internet, a cellular telephone carrier network, or the like, but may be constituted by any communication line or network.

Note that although each of management server 30a to management server 30c will also be called “management server 30” hereinafter, management server 30a to management server 30c may also be referred to as “management server A” to “management server C”.

Seller terminal 10 will be described hereinafter.

### Seller Terminal 10

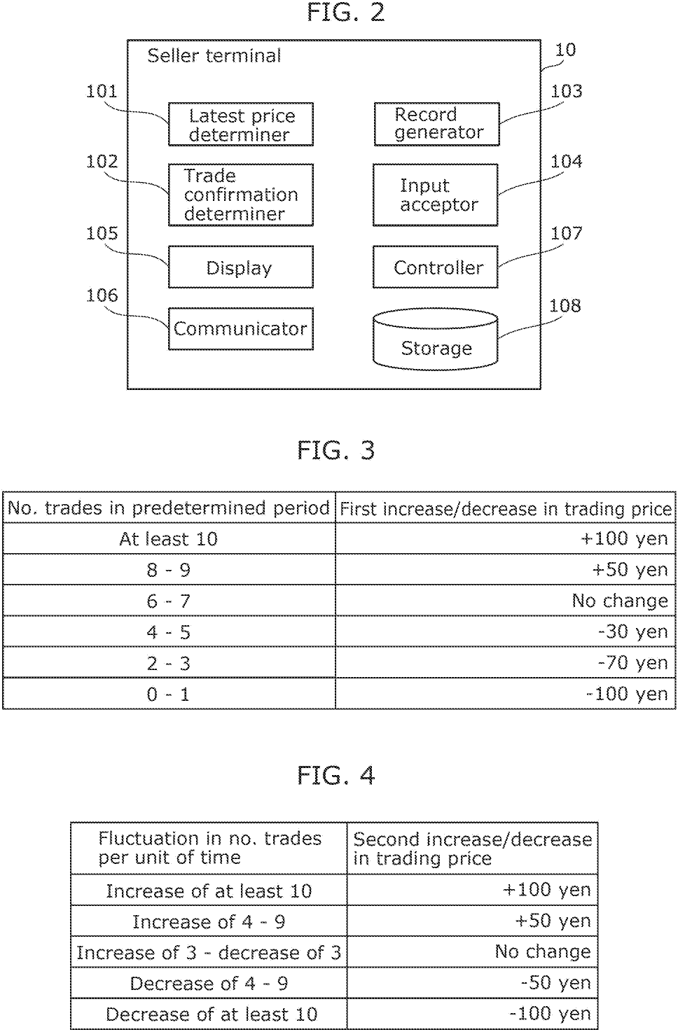

FIG. 2 is a diagram illustrating an example of the configuration of the seller terminal according to the embodiment.

Seller terminal 10 is an example of a first terminal owned by a seller of a target data set subject to trade. When a target data set is specified, seller terminal 10 transmits a request for a trade record of at least one similar data set similar to the target data set to management servers 30a to 30c, and obtains a trade record from management servers 30a to 30c in response to the stated request. Then, seller terminal 10 determines the trading price of the target data set based on the trade record of the at least one similar data set obtained. Seller terminal 10 is, for example, a computer such as a smartphone, a tablet terminal, a personal computer, or the like. Seller terminal 10 includes latest price determiner 101, trade confirmation determiner 102, record generator 103, input acceptor 104, display 105, communicator 106, controller 107, and storage 108. The seller terminal 10 may include, for example, a speaker, a vibrator, and a LED. Seller terminal 10 can be implemented by a processor executing a predetermined program using memory. Each constituent element will be described hereinafter.

Latest price determiner 101 determines a trading price of a target data set based on a trade record obtained from management servers 30a to 30c, the trade record being a trade record of at least one similar data set. Latest price determiner 101 is an example of a determiner. The trade record of the at least one similar data set includes a trade date/time of each of the at least one similar data set and a trading price of each of the at least one similar data set. Specifically, latest price determiner 101 specifies the trading price of one specific similar data set among the at least one similar data set from the trade record of the at least one similar data set, and determines the trading price of the target data set based on the trading price of the one specific similar data set specified. For example, the one specific similar data set is the newest similar data set among the at least one similar data set. In other words, latest price determiner 101 refers to the trade date/time included in the trade record of the at least one similar data set and specifies one specific similar data set having a trade record with the latest trade date/time among the at least one similar data set. Latest price determiner 101 then determines the trading price of the target data set based on the trading price included in the trade record of the one specific similar data set.

Latest price determiner 101 may determine the trading price of the one specific similar data set as-is as the trading price of the target data set.

Additionally, latest price determiner 101 may determine a higher price for the trading price of the target data set as the number of the at least one similar data set increases. Specifically, latest price determiner 101 may determine a result of adding a first increase/decrease amount based on the number of the at least one similar data set to the trading price of the one specific similar data set as the trading price of the target data set. Here, the first increase/decrease amount is determined to be a higher price as the number of similar data sets, among the at least one similar data set, increases in at least one period having a trade record in which the trade date/time is included in a predetermined period. The predetermined period is a period spanning from a predetermined time to the present time. The predetermined time is a time which is a predetermined time interval from the present time. The predetermined time interval may be, for example, one day, two days, one week, one month, or the like. For example, as illustrated in FIG. 3, the first increase/decrease amount of the trading price may be determined according to the number of trades in the predetermined period. FIG. 3 is a table showing relationships between the number of trades of a similar data set and the first increase/decrease amount in a trading price, in the predetermined period. In FIG. 3, the first increase/decrease amount is set to a positive value when the number of trades in the predetermined period is at least eight, and to a negative value when the number of trades is no greater than five, but the values are not limited thereto as long as the value is set higher as the number of trades increases. In other words, the first increase/decrease amount may be set only to positive values, or may be set only to negative values.

Additionally, latest price determiner 101 may determine a higher price for the trading price of the target data set as a number by which the at least one similar data set increases per unit of time increases. Specifically, latest price determiner 101 may determine a result of adding a second increase/decrease amount based on the number by which the at least one similar data set increases per unit of time to the trading price of the one specific similar data set as the trading price of the target data set. Here, the second increase/decrease amount is determined as a higher price as the number by which the data set increases per unit of time increases. The unit of time may be, for example, one day, two days, one week, one month, or the like. For example, as illustrated in FIG. 4, the second increase/decrease amount of the trading price may be determined according to fluctuations in the number of trades per unit of time. FIG. 4 is a table showing relationships between fluctuations in the number of trades per unit of time of the similar data set and the second increase/decrease amount in a trading price. In FIG. 4, the second increase/decrease amount is set to a positive value when the fluctuation in the number of trades per unit of time is an increase of at least four, and to a negative value when the fluctuation is a decrease of at least four, but the values are not limited thereto as long as the values are set to be higher as the fluctuations increase. In other words, the second increase/decrease amount may be set only to positive values, or may be set only to negative values.

Note that latest price determiner 101 may determine a result of adding the first increase/decrease amount and the second increase/decrease amount to the trading price of the one specific similar data set as the trading price of the target data set.

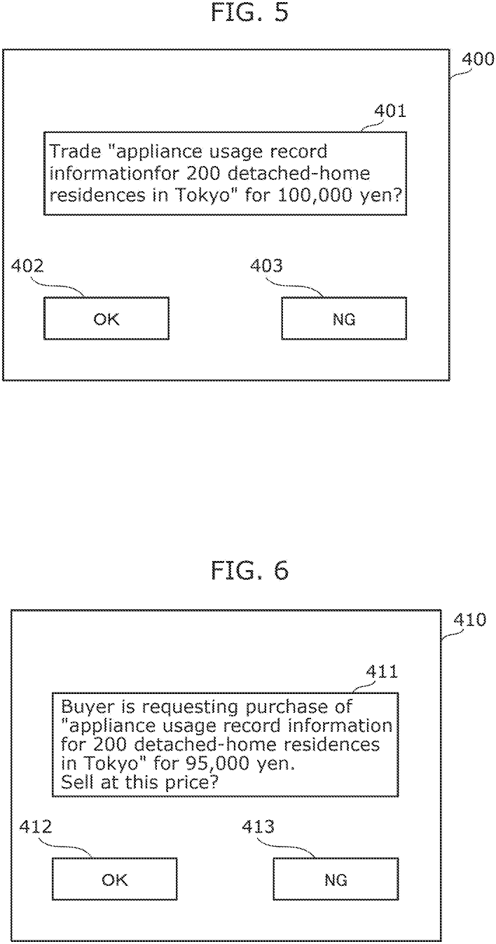

Trade confirmation determiner 102 determines whether to trade the target data set with the buyer based on the trading price of the target data set, determined by latest price determiner 101. Specifically, as illustrated in FIG. 5, trade confirmation determiner 102 may display, in display 105, UI 400 inquiring with the seller as to whether the seller is willing to trade at the trading price of the target data set, and may determine whether to make the trade in accordance with an input to UI 400 accepted by input acceptor 104. FIG. 5 is a diagram illustrating an example of the UI for inquiring with the seller as to whether the seller is willing to trade at the trading price of the target data set. UI 400 includes message 401 that inquires with the seller as to whether the seller is willing to trade at the trading price of the target data set, button 402 that accepts an affirmative response to the inquiry, and button 403 that accepts a negative response to the inquiry. When the input accepted by input acceptor 104 is an input which selects button 402 in UI 400, i.e., when an affirmative response to the inquiry has been accepted, trade confirmation determiner 102 determines to trade the target data set with the buyer at the trading price of the target data set. However, when the input accepted by input acceptor 104 is an input which selects button 403 in UI 400, i.e., when a negative response to the inquiry has been accepted, trade confirmation determiner 102 determines not to trade the target data set with the buyer at the trading price of the target data set.

Note that in addition to displaying a UI that inquires with the seller as to whether the seller is willing to trade at the trading price of the target data set, trade confirmation determiner 102 may display, in display 105, UI 410 inquiring with the seller as to whether the seller is willing to trade at a desired purchase price, as illustrated in FIG. 6. In this case, seller terminal 10 displays UI 410 in display 105 upon receiving, from buyer terminal 20, desired purchase price information indicating that the buyer wishes to purchase the target data set at the desired purchase price. FIG. 6 is a diagram illustrating an example of the UI for inquiring with a seller as to whether the seller is willing to trade the target data set at the desired purchase price. UI 410 includes message 411 that inquires with the seller as to a desired purchase price at which the purchase of the target data set by the buyer is acceptable, button 412 that accepts an affirmative response to the inquiry, and button 413 that accepts a negative response to the inquiry. When the input accepted by input acceptor 104 is an input which selects button 412 in UI 410, i.e., when an affirmative response to the inquiry has been accepted, trade confirmation determiner 102 may determine to trade the target data set with the buyer at the desired purchase price. However, when the input accepted by input acceptor 104 is an input which selects button 413 in UI 410, i.e., when a negative response to the inquiry has been accepted, trade confirmation determiner 102 may determine not to trade the target data set with the buyer at the desired purchase price.

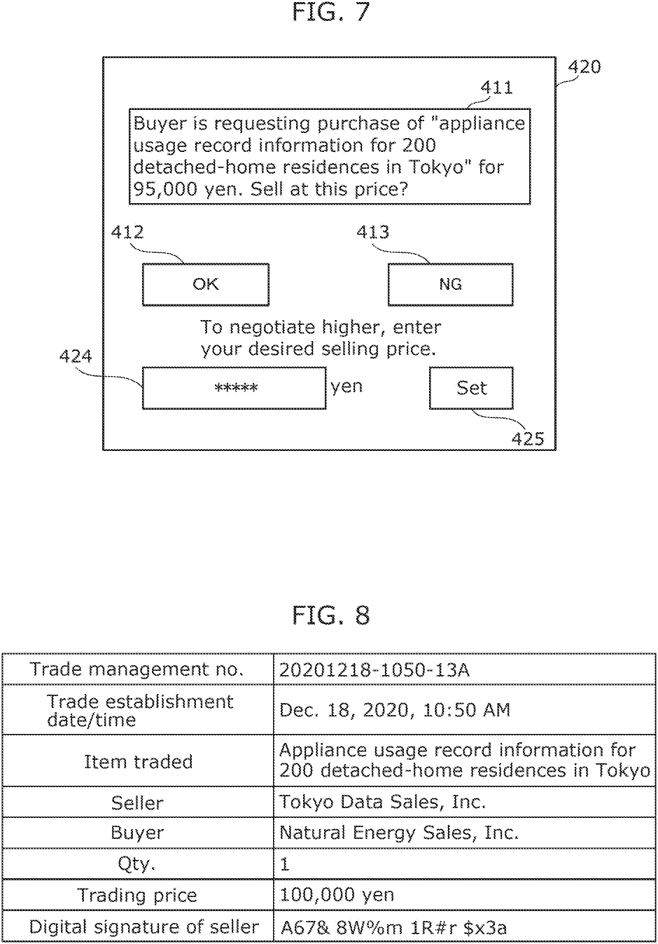

Additionally, as illustrated in FIG. 7, trade confirmation determiner 102 may display, in display 105, UI 420 for negotiating a price with the buyer. In this case, seller terminal 10 displays UI 420 in display 105 upon receiving, from buyer terminal 20, desired purchase price information indicating a desire to purchase the target data set at the desired purchase price. FIG. 7 is a diagram illustrating an example of the UI for negotiating the price with a buyer. Similar to UI 410 in FIG. 6, UI 420 includes message 411 and buttons 412 and 413, and further includes input field 424 for inputting a desired selling price for price negotiations, as well as set button 425. If input acceptor 104 accepts an input selecting set button 425 in a state where a desired selling price has been input in input field 424, without input acceptor 104 having accepted an input to buttons 412 and 413, desired selling price information indicating a desire to sell the target data set at the desired selling price is transmitted to buyer terminal 20. Then, if an affirmative response to the desired selling price information is obtained from buyer terminal 20, the trade of the target data set at the desired selling price may be made with the buyer, whereas if a negative response to the desired selling price information is obtained from buyer terminal 20, the trade of the target data set at the desired purchase price may not be made with the buyer.

If the trade of the target data set with the buyer is to be made, trade confirmation determiner 102 may transmit a notification that the trade will be made to buyer terminal 20 through communicator 106. On the other hand, if the trade of the target data set with the buyer is not to be made, trade confirmation determiner 102 may transmit a notification that the trade will not be made to buyer terminal 20 through communicator 106.

When a trade of a target data set is established, record generator 103 generates first trading record information indicating that the trade of the target data set has been established between the seller and the buyer at the determined trading price. The trade of the target data set is established when trade confirmation determiner 102 determines to trade the target data set with the buyer and a notification indicating that the trade of the target data set will be made with the seller is received from buyer terminal 20 by communicator 106.

FIG. 8 is a table showing an example of the first trading record information. As illustrated in FIG. 8, the first trading record information includes a trade management number identifying the trade record of a single target data set, a trade establishment date/time, the item traded, the seller, the buyer, a quantity, the trading price, and a digital signature of the seller. The item traded may be indicated by a condition for specifying the target data set. Note that the first trading record information need not include the quantity.

Input acceptor 104 accepts inputs from a user. Input acceptor 104 may be a touchpad, a touch panel, a keyboard, a mouse, or the like.

Display 105 is, for example, a display device that displays UIs 400, 410, 420, and the like.

Communicator 106 communicates with management servers 30 over network N. Through this, communicator 106 transmits, to management servers 30, a request for the trade record of at least one similar data set similar to the target data set. Communicator 106 also receives trade records from management servers 30 in response to the stated request. In other words, communicator 106 is an example of an obtainer that obtains a trade record.

Communicator 106 also communicates with buyer terminal 20 over network N. Through this, communicator 106 may transmit the desired selling price information to buyer terminal 20. Communicator 106 may also receive the desired purchase price information from buyer terminal 20.

Controller 107 generates a request for the trade record of at least one similar data set similar to the target data set in accordance with an input accepted by input acceptor 104. The request for the trade record includes a first condition for specifying the target data set.

Here, the first condition is a condition used to specify a plurality of instances of target data included in the target data set from among a plurality of instances of data generated by a plurality of devices. The first condition includes, for example, at least one condition among a condition pertaining to a type of the data, a condition pertaining to a period in which the data was generated, and a condition pertaining to a number of users of the device that generated the data. The first condition may include at least two conditions among the condition pertaining to the type of the data, the condition pertaining to the period in which the data was generated, and the condition pertaining to the number of users of the device that generated the data. The type of the data includes, for example, a recording reserved program for a BD (Blu-ray (registered trademark) Disc) recorder (including a TV having a program recording function); a start time or end time for a washing machine; a time to which a laundry cycle reservation has been made for a washing machine; a start time or end time for an air conditioner; new product sales data at a store such as a convenience store (i.e., POS (Point Of Sales) data obtained from a register); passenger data for a specific station (i.e., entry/exit data from an automatic ticket gate at a specific station); viewing data of a specific program in a video distribution service; and the like. The period in which the data is generated includes a specific month, a specific week, the last month, the last week, the last ten days, the last five days, multiple days of a specific day of the week included in a specific period (e.g., three months, two months, or the like), a specific time slot only included in a specific period (e.g., one week, two weeks, etc.), and the like. The number of users of the device that generated the data is the number of users of the same model of device as a specific device or the same type of device, and is the total number of users throughout Japan (nationwide), the total number of users for each regional government (prefecture, municipality, etc.), the total number of users in each region, and the total number of users for each of user attributes. The user attributes are, for example, age group, gender, number of members of the household, and so on, which are set for each user of the device when a service is registered.

Note that the plurality of instances of data are data generated by a plurality of devices including devices installed in residences (e.g., home appliances and the like) or devices installed in public facilities (e.g., automatic ticket gates at stations, registers in stores, and the like), and are, for example, operation logs generated by the plurality of devices. The plurality of instances of data may be stored in management servers 30, or may be stored in another server different from management servers 30. Each instance of data is generated as a result of each device operating. Each instance of data is information in which operation details of the device, the time at which the data was generated, the address of the residence or facility in which the device is installed, and the type of the device or the model of the device are associated with each other.

After a request for the trade record of the at least one similar data set similar to the target data set is generated, controller 107 controls communicator 106 to transmit the generated request to management servers 30. Controller 107 may also generate UIs 410 and 420 based on the desired purchase price information received by communicator 106 and cause UIs 410 and 420 to be displayed in display 105. Additionally, controller 107 may control communicator 106 to transmit the first trading record information generated by record generator 103 to buyer terminal 20. Alternatively, controller 107 may control communicator 106 to transmit seller signature information, indicating the digital signature of the seller, to buyer terminal 20. Note that if controller 107 transmits the seller signature information to buyer terminal 20, seller terminal 10 need not include record generator 103. The controller 107 may control at least one of the display 105, the speaker, the vibrator, the LED or the like to notify the seller of the seller terminal that the communicator 106 has received at least one similar data set or the desired purchase price information.

Storage 108 stores the trade record of the at least one similar data set, and the desired purchase price information, received by communicator 106. Storage 108 may also store information necessary for seller terminal 10 to operate, e.g., programs.

Buyer terminal 20 will be described next.

### Buyer Terminal 20

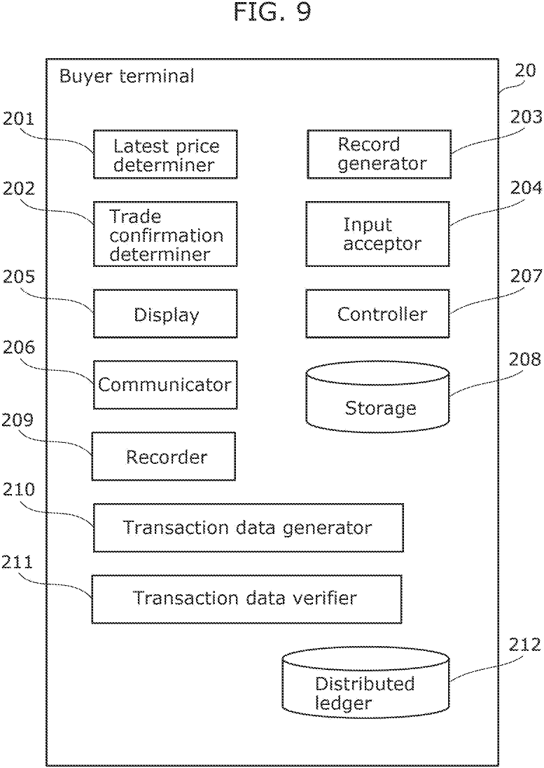

FIG. 9 is a diagram illustrating an example of the configuration of the buyer terminal according to the embodiment.

Buyer terminal 20 is an example of a second terminal owned by a buyer of a target data set subject to trade. When a target data set is specified, buyer terminal 20 transmits a request for a trade record of at least one similar data set similar to the target data set to management servers 30a to 30c, and obtains a trade record from management servers 30a to 30c in response to the stated request. Then, buyer terminal 20 determines the trading price of the target data set based on the trade record of the at least one similar data set obtained. Buyer terminal 20 is, for example, a computer such as a smartphone, a tablet terminal, a personal computer, or the like. Buyer terminal 20 includes latest price determiner 201, trade confirmation determiner 202, record generator 203, input acceptor 204, display 205, communicator 206, controller 207, storage 208, recorder 209, transaction data generator 210, transaction data verifier 211, and distributed ledger 212. Buyer terminal 20 may include, for example, a speaker, a vibrator, and a LED. Buyer terminal 20 can be implemented by a processor executing a predetermined program using memory. Each constituent element will be described hereinafter.

Latest price determiner 201 determines a trading price of a target data set based on a trade record obtained from management servers 30a to 30c, the trade record being a trade record of at least one similar data set. Latest price determiner 201 is an example of a determiner. Latest price determiner 201 performs the same processing as latest price determiner 101, and will therefore not be described in detail.

Trade confirmation determiner 202 determines whether to trade the target data set with the buyer based on the trading price of the target data set, determined by latest price determiner 201. Specifically, as illustrated in FIG. 10, trade confirmation determiner 202 may display, in display 205, UI 430 inquiring with the buyer as to whether the buyer is willing to trade at the trading price of the target data set, and may determine whether to make the trade in accordance with an input to UI 430 accepted by input acceptor 204. FIG. 10 is a diagram illustrating an example of the UI for inquiring with the buyer as to whether the buyer is willing to trade at the trading price of the target data set. UI 430 includes message 431 that inquires with the buyer as to whether the buyer is willing to trade at the trading price of the target data set, button 432 that accepts an affirmative response to the inquiry, and button 433 that accepts a negative response to the inquiry. When the input accepted by input acceptor 204 is an input which selects button 432 in UI 430, i.e., when an affirmative response to the inquiry has been accepted, trade confirmation determiner 202 determines to trade the target data set with the seller at the trading price of the target data set. However, when the input accepted by input acceptor 204 is an input which selects button 433 in UI 430, i.e., when a negative response to the inquiry has been accepted, trade confirmation determiner 202 determines not to trade the target data set with the seller at the trading price of the target data set.

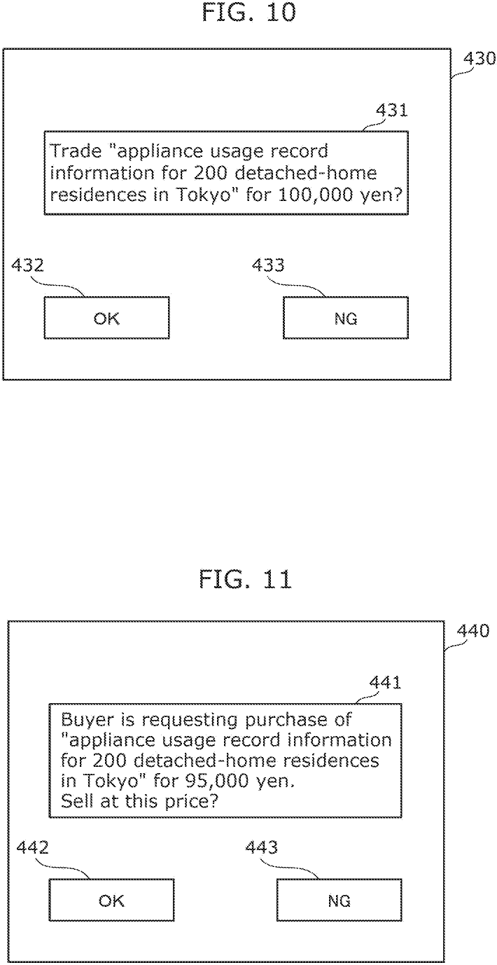

Note that in addition to displaying a UI that inquires with the buyer as to whether the buyer is willing to trade at the trading price of the target data set, trade confirmation determiner 202 may display, in display 205, UI 440 inquiring with the buyer as to whether the buyer is willing to trade at a desired selling price, as illustrated in FIG. 11. In this case, buyer terminal 20 displays UI 440 in display 205 upon receiving, from seller terminal 10, the desired selling price information indicating that the seller wishes to sell the target data set at the desired selling price. FIG. 11 is a diagram illustrating an example of the UI that inquires with the buyer as to whether the buyer is willing to trade the target data set at the desired selling price. UI 440 includes message 441 that inquires with the buyer as to a desired selling price at which the seller can accept the purchase of the target data set, button 442 that accepts an affirmative response to the inquiry, and button 443 that accepts a negative response to the inquiry. When the input accepted by input acceptor 204 is an input which selects button 442 in UI 440, i.e., when an affirmative response to the inquiry has been accepted, trade confirmation determiner 202 may determine to trade the target data set with the seller at the desired selling price. However, when the input accepted by input acceptor 204 is an input which selects button 443 in UI 440, i.e., when a negative response to the inquiry has been accepted, trade confirmation determiner 202 may determine not to trade the target data set with the seller at the desired selling price.

Additionally, as illustrated in FIG. 12, trade confirmation determiner 202 may display, in display 205, UI 450 for negotiating a price with the buyer. In this case, buyer terminal 20 displays UI 450 in display 205 upon receiving, from seller terminal 10, the desired selling price information indicating the desire to sell the target data set at the desired selling price. FIG. 12 is a diagram illustrating an example of the UI for negotiating the price with the seller. Similar to UI 440 in FIG. 11, UI 450 includes message 441 and buttons 442 and 443, and further includes input field 454 for inputting a desired purchase price for price negotiations, as well as set button 455. If input acceptor 204 accepts an input selecting set button 455 in a state where a desired purchase price has been input in input field 454, without input acceptor 204 having accepted an input to buttons 442 and 443, desired purchase price information indicating a desire to purchase the target data set at the desired purchase price is transmitted to seller terminal 10. Then, if an affirmative response to the desired purchase price information is obtained from seller terminal 10, the trade of the target data set at the desired purchase price may be made with the seller, whereas if a negative response to the desired purchase price information is obtained from seller terminal 10, the trade of the target data set at the desired selling price of the seller may not be made with the seller.

If the trade of the target data set with the seller is to be made, trade confirmation determiner 202 may transmit a notification that the trade will be made to seller terminal 10 through communicator 206. On the other hand, if the trade of the target data set with the seller is not to be made, trade confirmation determiner 202 may transmit a notification that the trade will not be made to seller terminal 10 through communicator 206.

When a trade of a target data set is established, record generator 203 generates second trading record information indicating that the trade of the target data set has been established between the seller and the buyer at the determined trading price. The trade of the target data set is established when trade confirmation determiner 202 determines to trade the target data set with the seller and a notification indicating that the trade of the target data set will be made with the buyer is received from seller terminal 10 by communicator 206.

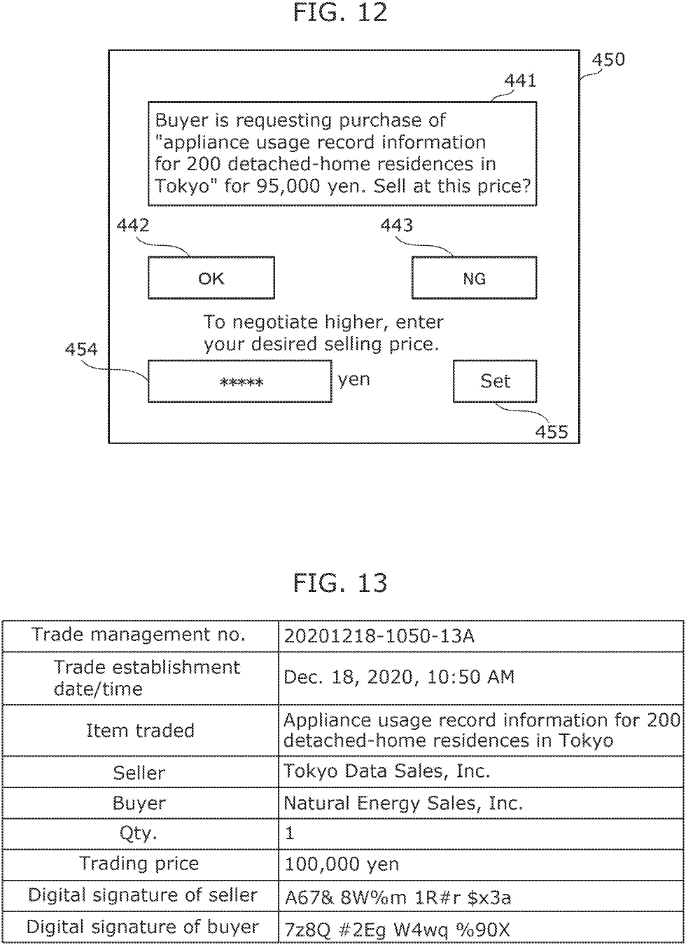

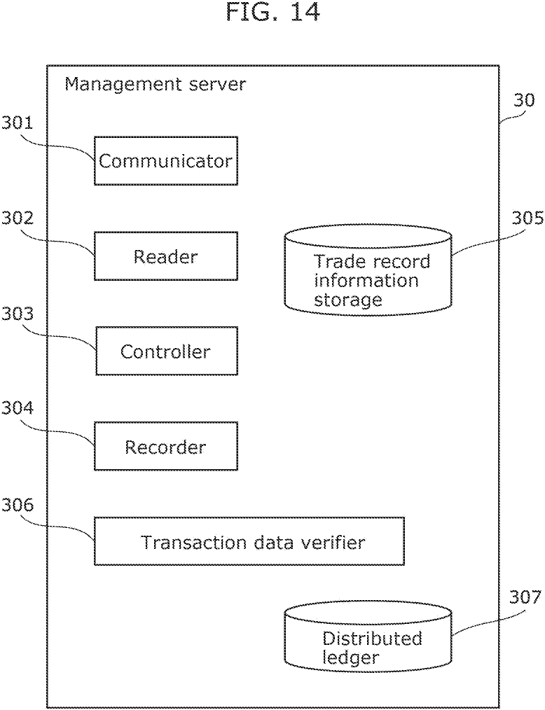

FIG. 13 is a table showing an example of the second trading record information. As illustrated in FIG. 13, the second trading record information includes a trade management number identifying the trade record of a single target data set, a trade establishment date/time, the item traded, the seller, the buyer, a quantity, the trading price, a digital signature of the seller, and a digital signature of the buyer. The item traded may be indicated by the first condition for specifying the target data set. Note that the second trading record information need not include the quantity.

When communicator 206 has received the first trading record information from seller terminal 10, record generator 203 may generate the second trading record information by further adding the digital signature of the buyer to the first trading record information. When communicator 206 has received the seller signature information from seller terminal 10, record generator 203 may generate the second trading record information by adding the signature of the seller, indicated by seller signature information, to the trade record information including the trade management number identifying the trade record of the single target data set, the trade establishment date/time, the item traded, the seller, the buyer, the quantity, the trading price, and the digital signature of the buyer.

Input acceptor 204 accepts inputs from a user. Input acceptor 204 may be a touchpad, a touch panel, a keyboard, a mouse, or the like.

Display 205 is, for example, a display device that displays UIs 430, 440, 450, and the like.

Communicator 206 communicates with management servers 30 over network N. Through this, communicator 206 transmits, to management servers 30, a request for the trade record of at least one similar data set similar to the target data set. Communicator 206 also receives trade records from management servers 30 in response to the stated request. In other words, communicator 206 is an example of an obtainer that obtains a trade record.

Communicator 206 also communicates with seller terminal 10 over network N. Through this, communicator 206 may transmit the desired purchase price information to seller terminal 10. Communicator 206 may also receive the desired selling price information from seller terminal 10.

Controller 207 generates a request for the trade record of at least one similar data set similar to the target data set in accordance with an input accepted by input acceptor 204. The request for the trade record includes a first condition for specifying the target data set. The first condition is the same as that described with reference to seller terminal 10, and will therefore not be described in detail here. After a request for the trade record of the at least one similar data set similar to the target data set is generated, controller 207 controls communicator 206 to transmit the generated request to management servers 30. Controller 207 may also generate UIs 440 and 450 based on the desired selling price information received by communicator 206 and cause UIs 440 and 450 to be displayed in display 205. The controller 207 may control at least one of the display 205, the speaker, the vibrator, the LED or the like to notify the buyer of the buyer terminal 20 that the communicator 206 has received at least one similar data set or the desired selling price information.

Storage 208 stores the trade record of the at least one similar data set, and the desired selling price information, received by communicator 206. Storage 208 may also store information necessary for buyer terminal 20 to operate, e.g., programs.

Transaction data generator 210 generates trade transaction data. In the present embodiment, transaction data generator 210 generates the trade transaction data, which includes the second trading record information generated by record generator 203, after the trade of the target data set is established.

Transaction data generator 210 transmits the generated trade transaction data to the plurality of management servers 30 via communicator 206.

When communicator 206 receives transaction data, transaction data verifier 211 verifies the validity of the transaction data. For example, transaction data verifier 211 verifies whether the transaction data received by communicator 206 has been given a digital signature generated by a correct method. Note that this verification may be skipped. Here, the transaction received by communicator 206 is, for example, trade transaction data.

Additionally, transaction data verifier 211, along with the plurality of management servers 30, executes a consensus algorithm for agreeing on the validity of the transaction data.

Here, Practical Byzantine Fault Tolerance (PBFT) may be used as the consensus algorithm, or another publicly-known consensus algorithm may be used. For example, Proof of Work (PoW), Proof of Stake (PoS), or the like can be given as publicly-known consensus algorithms. When PBFT is used as the consensus algorithm, transaction data verifier 211 receives a report from each of the plurality of management servers 30 indicating whether the verification of the transaction data has succeeded, and determines whether the number of the reports exceeds a predetermined number. When the number of the reports exceeds the predetermined number, transaction data verifier 211 may determine that the validity of the transaction data has been verified by the consensus algorithm.

When the validity of the transaction data has been confirmed, transaction data verifier 211 causes recorder 209 to record that transaction data.

In the present embodiment, transaction data verifier 211 verifies the validity of the trade transaction data received by communicator 206.

Note that by including the transaction data for which the validity has been verified by transaction data verifier 211 in blocks and recording the blocks into distributed ledger 212, recorder 209 records the transaction data. If the validity of the transaction data cannot be confirmed, that transaction data may be discarded, and the processing of recording the transaction data in recorder 209 and distributed ledger 212 may be skipped. This makes it possible to reduce unnecessary consumption of the memory and reduce the amount of processing performed by the processor.

Note also that recorder 209 may be configured within distributed ledger 212.

Distributed ledger 212 stores the trade transaction data.

Management servers 30 will be described next.

### Management Server 30

FIG. 14 is a diagram illustrating an example of the configuration of the management servers according to the embodiment.

As illustrated in FIG. 14, management server 30 includes communicator 301, reader 302, controller 303, recorder 304, trade record information storage 305, transaction data verifier 306, and distributed ledger 307. Management server 30 can be implemented by a processor executing a predetermined program using memory. Management server 30 is an example of a server. Each constituent element will be described hereinafter.

Communicator 301 communicates with seller terminal 10 over network N. Communicator 301 receives a request for a trade record of at least one similar data set similar to the target data set from seller terminal 10. Communicator 301 also transmits a trade record to seller terminal 10 in response to the stated request. Similarly, communicator 301 communicates with buyer terminal 20 over network N. Communicator 301 receives a request for a trade record of at least one similar data set similar to the target data set from buyer terminal 20. Communicator 301 also transmits a trade record to buyer terminal 20 in response to the stated request.

Communicator 301 also communicates with buyer terminal 20 and another management server 30 over network N. Communicator 301 exchanges trade transaction data with buyer terminal 20 and the other management server 30.

Note that the communication by communicator 301 may be performed using Transport Layer Security (TLS), and communicator 301 may hold an encryption key for TLS communication.

Reader 302 reads out the trade record pertaining to the request received by communicator 301 from trade record information storage 305. Specifically, based on the first condition for specifying the target data set, which is included in the request, reader 302 specifies at least one similar data set specified by a second condition similar to the first condition, and reads out the trade record of the specified at least one similar data set from trade record information storage 305. In other words, each of the at least one similar data set includes a plurality of instances of second data, among a plurality of instances of data, that satisfy the second condition.

Controller 303 determines the second condition similar to the first condition for specifying the target data set, included in the request received by communicator 301. Controller 303 may determine the second condition by skipping changing at least one condition among at least two conditions included in the first condition, while changing at least one other condition. For example, if the first condition includes three conditions, namely a condition pertaining to the type of the data, a condition pertaining to the period in which the data was generated, and a condition pertaining to the number of users of the device that generated the data, the second condition may be generated by changing the condition pertaining to the period in which the data was generated, without changing the condition pertaining to the type of the data and the condition pertaining to the number of users of the device that generated the data. In this case, the second condition includes the same condition pertaining to the type of the data and the condition pertaining to the number of users of the device that generated the data as the first condition, and a condition pertaining to the period in which the data was generated that has been changed from the first condition. In this manner, controller 303 may generate the second condition including a condition that is the same as the first condition and another condition changed from the first condition, as a condition similar to the first condition, by skipping changing at least one condition among a plurality of conditions included in the first condition while changing at least one other condition. Controller 303 may, for example, change the condition pertaining to the period in which the data was generated by changing a start time and an end time without changing the length of the period. Controller 303 can generate a plurality of the second conditions by changing the start time and the end time according to a plurality of patterns. For example, controller 303 may change the condition pertaining to the number of users of the device that generated the data by changing a region including the addresses where the users reside, without changing the number of users. Controller 303 can generate a plurality of the second conditions by changing the region according to a plurality of patterns. In this manner, controller 303 may generate a plurality of second conditions similar to the first condition.

Through this, reader 302 specifies at least one similar data set from among the plurality of instances of data using at least one second condition generated by controller 303. Each of the at least one similar data set includes a plurality of instances of second data that, among the plurality of instances of data, satisfy the second condition corresponding to that similar data set. In other words, reader 302 specifies at least one similar data set similar to the target data set, specifies a similar data set, among the at least one similar data set specified, that has a trade record, from the at least one instance of trade record information stored in distributed ledger 307, and reads out, from trade record information storage 305, the trade record of the at least one similar data set that has been specified.

Additionally, by controlling communicator 301, controller 303 transmits the at least one similar data set read out by reader 302 to the terminal that transmitted the request, i.e., to seller terminal 10 or buyer terminal 20.

When communicator 301 receives transaction data, transaction data verifier 306 verifies the validity of the transaction data. For example, transaction data verifier 306 verifies whether the transaction data received by communicator 301 has been given a digital signature generated by a correct method. Note that this verification may be skipped. Here, the transaction received by communicator 301 is, for example, trade transaction data.

Additionally, transaction data verifier 306, along with a plurality of other management servers 30, executes a consensus algorithm for agreeing on the validity of the transaction data.

Here, Practical Byzantine Fault Tolerance (PBFT) may be used as the consensus algorithm, or another publicly-known consensus algorithm may be used. For example, Proof of Work (PoW), Proof of Stake (PoS), or the like can be given as publicly-known consensus algorithms. When PBFT is used as the consensus algorithm, transaction data verifier 306 receives a report from each of the plurality of management servers 30 indicating whether the verification of the transaction data has succeeded, and determines whether the number of the reports exceeds a predetermined number. When the number of the reports exceeds the predetermined number, transaction data verifier 306 may determine that the validity of the transaction data has been verified by the consensus algorithm.

When the validity of the transaction data has been confirmed, transaction data verifier 306 causes recorder 304 to record that transaction data.

In the present embodiment, transaction data verifier 306 verifies the validity of the trade transaction data received by communicator 301.

Note that by including the transaction data for which the validity has been verified by transaction data verifier 306 in blocks and recording the blocks into distributed ledger 307, recorder 304 records the transaction data. If the validity of the transaction data cannot be confirmed, that transaction data may be discarded, and the processing of recording the transaction data in recorder 304 and distributed ledger 307 may be skipped. This makes it possible to reduce unnecessary consumption of the memory and reduce the amount of processing performed by the processor.

Note also that recorder 304 may be configured within distributed ledger 307.

Distributed ledger 307 stores the trade transaction data. Distributed ledger 307 obtains and stores the trade transaction data in sequence, and therefore stores at least one instance of the trade transaction data. In this manner, management servers 30 store at least one instance of trade transaction data, each including trade record information, in distributed ledger 307. The trade record information is included in each of the at least one instance of trade transaction data. The trade record information includes a trade record of the data set subject to being traded, indicated by that trade record information. The data set including a trade record includes at least one instance of data, among a plurality of instances of data generated by a plurality of devices, that satisfies a condition corresponding to that data set.

Although buyer terminal 20 is described as executing a consensus algorithm with the plurality of management servers 30 and storing the trade transaction data in distributed ledger 212 as a block, the configuration is not limited thereto. Buyer terminal 20, recorder 209, transaction data generator 210, transaction data verifier 211, and distributed ledger 212 need not be included. In other words, any configuration may be used as long as at least a plurality of management servers 30 include distributed ledger 307, the consensus algorithm is executed, and the trade transaction data is stored in distributed ledger 307 as a block. Accordingly, similar to buyer terminal 20, seller terminal 10 may have the same functions as recorder 209, transaction data generator 210, transaction data verifier 211, and distributed ledger 212.

### Operations

Operations of the management system configured as described above will be described next.

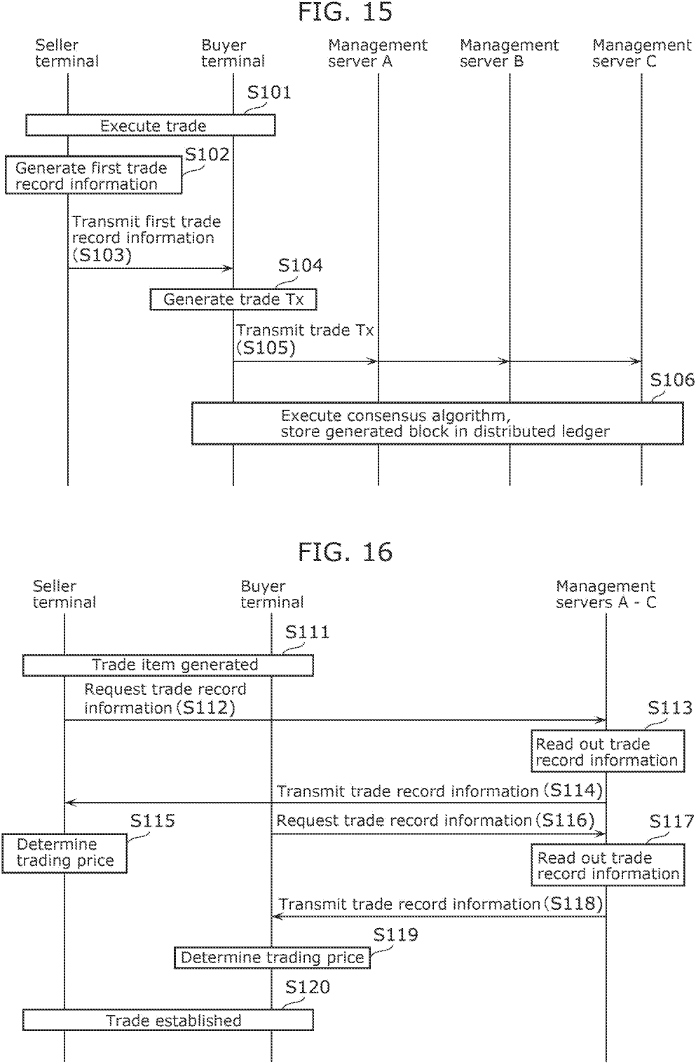

FIG. 15 is a flowchart illustrating an example of operations for storing the trade record information in the distributed ledger, performed by the management system according to the embodiment.

First, seller terminal 10 and buyer terminal 20 execute a trade of a target data set (S101). The execution of the trade will be described in detail later with reference to FIG. 16.

Once the trade is established in step S101, seller terminal 10 generates the first trading record information indicating that the trade of the target data set has been established between the seller and the buyer at the determined trading price (S102).

Seller terminal 10 then transmits the generated first trading record information to buyer terminal 20 (S103).

Upon receiving the first trading record information, buyer terminal 20 generates the second trading record information by adding the digital signature of the buyer to the first trading record information, and generates trade transaction data including the second trading record information (S104). Note that in FIG. 15, the trade transaction data is indicated by “trade Tx”.

Next, buyer terminal 20 transmits the generated trade transaction data to management servers A to C (S105).

Next, buyer terminal 20 and management servers A to C execute a consensus algorithm, generate a block including the trade transaction data, and store the block in distributed ledgers 212 and 307 (S106). Through this, the second trading record information included in the trade transaction data is stored in distributed ledgers 212 and 307.

Note that the trade transaction data may be transmitted to the management server, and the management server that has received the trade transaction may verify the validity of the trade transaction data. When the validity has been verified, the management server then transmits the trade transaction data to the other management servers. When the validity has not been verified, the management server does not transmit the trade transaction data to the other management servers. As a result, controller 303 of the management server is capable of reducing the processing amount which reduces the power consumption of the management server.

Note that the trade transaction data may be generated by one management server among management servers A to C. In this case, the second trading record information generated by buyer terminal 20 is transmitted to the management server, and the management server that has received the second trading record information generates the trade transaction data including the received second trading record information. That management server then transmits the trade transaction data to the other management servers. In this manner, the processing of step S106 may be started among management servers A to C.

Note that the management server may receive one or more trade transaction data from one or more of buyer terminal 20. The management server may generate a block including the one or more trade transaction data when the number of one or more trade transaction data is greater than a predetermined threshold value. As a result, compared to generating a block including a trade transaction data and storing the block in distributed ledgers each time, unnecessary consumption of the memory capacity can be reduced and is capable of reducing the processing amount of the controller.

FIG. 16 is a flowchart illustrating an example of operations for executing a trade, performed by the management system according to the embodiment.

First, a trade item is generated between seller terminal 10 and buyer terminal 20 (S111). Step S111 may be performed by, for example, buyer terminal 20 transmitting, to seller terminal 10, desired purchase price information indicating the purchase of a target data set satisfying the first condition at a desired purchase price.

Next, seller terminal 10 transmits, to management servers A to C, a request for the trade record information of at least one similar data set similar to the target data set (S112). This request includes the second condition similar to the first condition for specifying the target data set.

Management servers A to C read out the trade record information in response to the request (S113), and transmit the read-out trade record information to seller terminal 10 (S114). Note that if one of management servers A to C transmits the trade record information to seller terminal 10, the other management servers need not transmit the trade record information to seller terminal 10.

Seller terminal 10 determines the trading price of the target data set based on the received trade record information (S115).

Next, buyer terminal 20 transmits, to management servers A to C, a request for the trade record information of at least one similar data set similar to the target data set (S116). This request includes the second condition similar to the first condition for specifying the target data set.

Management servers A to C read out the trade record information in response to the request (S117), and transmit the read-out trade record information to buyer terminal 20 (S118). Note that if one of management servers A to C transmits the trade record information to buyer terminal 20, the other management servers need not transmit the trade record information to buyer terminal 20.

Buyer terminal 20 determines the trading price of the target data set based on the received trade record information (S119).

Seller terminal 10 and buyer terminal 20 negotiate based on the trading price determined therebetween, and when an input indicating the trade is acceptable is obtained from both the seller and the buyer, the trade is determined to have been established, and the trade is executed (S120). Once the trade is established, the seller of seller terminal 10 obtains compensation corresponding to the determined trading price from the buyer, who is the owner of buyer terminal 20. For example, a token equivalent to the trading price may be paid from an account of the buyer to an account of the seller. Additionally, once the trade is established, the buyer, who is the owner of buyer terminal 20, obtains permission to obtain the target data set. For example, buyer terminal 20 may obtain permission information, indicating permission to obtain the target data set from a server in which the target data set is stored, from seller terminal 10, management servers A to C, another device, or the like. Buyer terminal 20 can obtain the target data set from the server in which the target data set is stored by using the permission information. Effects, etc.

The data trading method according to the present embodiment is a data trading method (a data management method) using a management system including a plurality of management servers holding a distributed ledger. The plurality of management servers 30a to 30c store at least one instance of trade transaction data (transaction data), each including trade record information (record information), in distributed ledger 307. Each of at least one instance of the trade record information included in a corresponding one of the at least one instance of trade transaction data includes a trade record of a data set subject to trading, indicated by the trade record information. Each of at least one data set included in a corresponding one of the at least one instance of trade record information includes at least one instance of data, among a plurality of instances of data generated by a plurality of devices, that satisfies a condition corresponding to the data set. The data trading method is executed by one terminal among seller terminal 10, which is owned by the seller (a first user) of the target data set subject to the trade, and buyer terminal 20, which is owned by the buyer (a second user) of the target data set. The data trading method obtains, from the at least one instance of trade record information stored in the distributed ledger 307, a trade record of at least one similar data set similar to the target data set, and determines a trading price (a value) of the target data set based on the trade record of the at least one similar data set obtained.

Through this, the trading price of the target data set is determined based on the trade record information stored in distributed ledger 307 of the plurality of management servers 30a to 30c, and thus the trading price can be determined based on trade record information which cannot be tampered with and which is publicized and transparent. This makes it possible to determine an appropriate price for the trading price of the target data set.

Furthermore, determining the trading price of the target data set based on a trade record established in the past provides an advantage in that it is easy to determine an appropriate trading price according to the market price of the target data set. However, generally speaking, a target data set subject to trade includes a plurality of instances of data, and may have a variety of combinations according to conditions. It is therefore unlikely that a data set specified by exactly the same condition as the first condition for specifying the target data set has been traded in the past. Accordingly, in the data trading method, the trading price of the target data set is determined based on the trade record of at least one similar data set similar to the target data set, which makes it easy to determine an appropriate trading price according to the market price of the target data set even when there is no data set specified by exactly the same condition as the first condition for specifying the target data set.

Additionally, the trading price of the target data set is determined based on the trade record included in distributed ledger 307 of the plurality of management servers 30a to 30c, and thus even if communication is not possible with the one management server 30a, the trading price can be determined by obtaining the trade record from the other management servers 30b and 30c. In other words, even if the one management server 30a has malfunctioned, the communication path with the one management server 30a has failed, or the like, and the trade record cannot be obtained from the one management server 30a, the trade record can be obtained from the other management servers 30b and 30c, which makes it possible to reduce the likelihood that the trade record cannot be obtained and the trading price cannot be determined. Accordingly, the retransmission of requests to the one management server 30a caused by the communication failure can be reduced, the processing load or the communication load until the trade record is obtained can be reduced, and the time required to obtain the trade record can be reduced as well. This makes it possible to reduce the power required to be consumed to obtain a single trade record.

Additionally, in the data trading method according to the present embodiment, one terminal among the seller terminal 10 and the buyer terminal 20 generates the trade transaction data including the trade record information that includes the trade record of the target data set, after a trade of the target data set is established; the one terminal transmits the trade transaction data to at least one of the plurality of management servers 30a to 30c; and the plurality of management servers 30a to 30c store the trade transaction data received by at least one server in the distributed ledger 307 by executing a consensus algorithm.

Through this, trade transaction data including newly-generated trade record information is stored in the distributed ledger, and thus the trade record information can be stored in the distributed ledger as trade record information for determining the trading price of the target data set, which cannot be tampered with and which is publicized and transparent.

Additionally, in the data trading method according to the present embodiment, the determining of the trading price includes determining the trading price of the target data set based on the trading price of one similar data set among the at least one similar data set.

Through this, the trading price of the target data set is determined based on the trading price of one similar data set estimated to be close to the market trading price of the target data set, and thus an appropriate trading price can be determined according to the market price of the target data set.

Additionally, in the data trading method according to the present embodiment, one similar data set having a trade record of the trading price serving as a reference is a newest similar data set among the at least one similar data set.

Through this, the trading price of the target data set is determined based on the trading price of the newest similar data set estimated to be close to the market trading price of the target data set, and thus an appropriate trading price can be determined according to the market price of the target data set.

Additionally, in the data trading method according to the present embodiment, the determining of the trading price includes setting the trading price of the target data set higher as a total number of the at least one similar data set increases.

The demand for the target data set is estimated to be greater as the number of the at least one similar data set estimated to be close to the market price of the target data set increases, and thus the trading price can be determined according to the demand.

Additionally, in the data trading method according to the present embodiment, the determining of the trading price includes setting the trading price of the target data set higher as a number by which the at least one similar data set increases per unit of time increases.

The demand for the target data set is estimated to be greater as the number of the at least one similar data set estimated to be close to the market price of the target data set increases, and thus the trading price can be determined according to the demand.

### Variation 1

The foregoing embodiment described trade confirmation determiner 102 of seller terminal 10 and trade confirmation determiner 202 of buyer terminal 20 as determining to trade the target data set based on the trading price when an input indicating an affirmative response to the trade is made from the seller to the buyer and an input indicating an affirmative response to the trade is made from the buyer to the seller, but the configuration is not limited thereto, and the trade of the target data set may be made automatically without waiting for inputs from the seller and the buyer.

### First Example

In a first example, trade confirmation determiner 102 of seller terminal 10 may obtain the trading price of the target data set from buyer terminal 20, compare that trading price with the trading price of the target data set determined by latest price determiner 101, and determine to trade the target data set at that trading price if the two trading prices match. Likewise, trade confirmation determiner 202 of buyer terminal 20 may obtain the trading price of the target data set from seller terminal 10, compare that trading price with the trading price of the target data set determined by latest price determiner 201, and determine to trade the target data set at that trading price if the two trading prices match. In this manner, if the trading price determined by seller terminal 10 and the trading price determined by buyer terminal 20 for the target data set match, the trade of the target data set at that trading price may be finalized.

### Second Example

A second example is an example in which a single trading price is determined automatically by comparing ranges of trading prices acceptable to both parties, rather than determining a single trading price as in the first example. Specifically, latest price determiner 101 of seller terminal 10 determines a first trading price range (a first value range) for determining the trading price of the target data set, the first trading price range being acceptable to the seller. The first trading price range may be determined based on the trading price determined by latest price determiner 101. For example, the first trading price range may be determined as a predetermined price range which takes the trading price determined by latest price determiner 101 as the median. In other words, the first trading price range may be determined as a range of positive and negative predetermined price differences from the trading price determined by latest price determiner 101. Alternatively, for example, the first trading price range may be determined as a predetermined price range which takes the trading price determined by latest price determiner 101 as a minimum price. Or, for example, the first trading price range may be determined as a predetermined price range which takes the trading price determined by latest price determiner 101 as a maximum price. The predetermined price difference or the predetermined price range may be set in seller terminal 10 in advance by the seller.

Likewise, latest price determiner 201 of buyer terminal 20 determines a second trading price range (a second value range) for determining the trading price of the target data set, the second trading price range being acceptable to the buyer. The second trading price range may be determined based on the trading price determined by latest price determiner 201. For example, the second trading price range may be determined as a predetermined price range which takes the trading price determined by latest price determiner 201 as the median. In other words, the second trading price range may be determined as a range of positive and negative predetermined price differences from the trading price determined by latest price determiner 201. Alternatively, for example, the second trading price range may be determined as a predetermined price range which takes the trading price determined by latest price determiner 201 as a minimum price. Or, for example, the second trading price range may be determined as a predetermined price range which takes the trading price determined by latest price determiner 201 as a maximum price. The predetermined price difference or the predetermined price range may be set in buyer terminal 20 in advance by the buyer.

Seller terminal 10 obtains the second trading price range from buyer terminal 20. Next, seller terminal 10 specifies an overlapping price range (an overlapping value range) where the first trading price range and the second trading price range overlap. Seller terminal 10 may then determine a price included in the overlapping price range as the trading price of the target data set. Note that this processing may be performed by buyer terminal 20. In other words, buyer terminal 20 obtains the first trading price range from seller terminal 10. Next, buyer terminal 20 specifies an overlapping price range where the first trading price range and the second trading price range overlap. Buyer terminal 20 may then determine a price included in the overlapping price range as the trading price of the target data set. Note that in the determination of the trading price of the target data set, a median value of the overlapping price range may be determined as the trading price of the target data set. In other words, the average value of the minimum value and the maximum value of the overlapping price range may be determined as the trading price of the target data set.

For example, when the first trading price range is from 96 yen to 100 yen, and the second trading price range is from 94 yen to 98 yen, the overlapping price range is from 96 yen to 98 yen. Accordingly, the trading price of the target data set is determined to be 97 yen, which is the median value between 96 yen and 98 yen.

### Variation 2

In the foregoing embodiment, when a price is being negotiated between seller terminal 10 and buyer terminal 20, a number of times that the desired selling price and the desired purchase price (expressed as a “desired price” when both are included) are reconsidered may be set to a predetermined number of times. The number of times the desired selling price is reconsidered and the number of times the desired purchase price is reconsidered may be set to the same number of times, or to different numbers of times. When set to different numbers of times, a maximum number of times for both may be set using the lower of the two as an upper limit. By restricting a number of times that the desired selling price and the desired purchase price are reconsidered, the processing amount of the controller can be reduced.

The desired price determined through such reconsideration may be set to a price obtained by adding or subtracting a set amount to or from the previous desired price. Additionally, the desired price determined through reconsideration may be determined such that half the difference from the partner’s previous desired price is added or subtracted. In this case, the addition or the subtraction is executed by an operation for approaching the partner’s previous desired price.

### Variation 3

The foregoing embodiment described a situation where a single desired price can be input in input fields 424 and 454 of UIs 420 and 450, the configuration is not limited thereto, and it may be possible to input the first trading price range and the second trading price range.

### Variation 4

The foregoing embodiment described seller terminal 10 as generating the first trading record information and transmitting the first trading record information to buyer terminal 20, and buyer terminal 20 as generating the trade transaction data by adding the digital signature of the buyer to the first trading record information, but the configuration is not limited thereto, and the processing of seller terminal 10 and the processing of buyer terminal 20 may be reversed. In other words, buyer terminal 20 may generate the second trading record information and transmit the second trading record information to seller terminal 10, and seller terminal 10 may generate the trade transaction data by adding the digital signature of the seller to the second trading record information.

### Variation 5

In the foregoing embodiment, in order to suppress an increase in the trade records due to an increase in trade volume, trades in which the seller and the buyer are the same person may be prohibited. In other words, a trade record from a trade in which the seller and the buyer are the same person is not stored in the distributed ledger. As a result, the processing amount of the controller can be reduced and unnecessary consumption of the memory capacity can be reduced.

### Other Embodiments

Although the present disclosure has been described above based on the aforementioned embodiments, the present disclosure is of course not limited to the embodiments discussed above. The present disclosure is also inclusive of the following cases.

Each device in the foregoing embodiments is specifically a computer system constituted by a microprocessor, ROM, RAM, a hard disk unit, a display unit, a keyboard, a mouse, and the like. A computer program is recorded in the RAM or hard disk unit. Each device realizes the functions thereof by the microprocessor operating in accordance with the computer program. Here, the computer program is constituted by a combination of a plurality of command codes that indicate commands made to a computer to achieve a predetermined function.

Some or all of the constituent elements constituting the devices in the foregoing embodiments may be implemented by a single integrated circuit through system LSI (Large-Scale Integration). “System LSI” refers to very-large-scale integration in which multiple constituent elements are integrated on a single chip, and specifically, refers to a computer system configured including a microprocessor, ROM, RAM, and the like. A computer program is recorded in the RAM. The system LSI circuit realizes the functions thereof by the microprocessor operating in accordance with the computer program.

The parts of the constituent elements constituting the foregoing devices may be implemented individually as single chips, or may be implemented with a single chip including some or all of the devices.

Although the term “system LSI” is used here, other names, such as IC, LSI, super LSI, ultra LSI, and so on may be used, depending on the level of integration. Furthermore, the manner in which the circuit integration is achieved is not limited to LSI, and it is also possible to use a dedicated circuit or a generic processor. An FPGA (Field Programmable Gate Array) capable of post-production programming or a reconfigurable processor in which the connections and settings of the circuit cells within the LSI can be reconfigured may be used as well.

Furthermore, if other technologies that improve upon or are derived from semiconductor technology enable integration technology to replace LSI circuits, then naturally it is also possible to integrate the function blocks using that technology. Biotechnology applications are one such foreseeable example.

Some or all of the constituent elements constituting the foregoing devices may be constituted by IC cards or stand-alone modules that can be removed from and mounted in the device. The IC card or the module is a computer system constituted by a microprocessor, ROM, RAM, and the like. The IC card or module may include the above very-large-scale integration LSI circuit. The IC card or module realizes the functions thereof by the microprocessor operating in accordance with the computer program. The IC card or module may be tamper-resistant.

The present disclosure may be realized by the methods described above. This may be a computer program that implements these methods on a computer, or a digital signal constituting the computer program.

Additionally, the present disclosure may also be computer programs or digital signals recorded in a computer-readable recording medium such as a flexible disk, a hard disk, a CD-ROM, an MO, a DVD, a DVD-ROM, a DVD-RAM, a BD (Blu-ray (registered trademark) Disc), semiconductor memory, or the like, for example. The constituent elements may also be the digital signals recorded in such a recording medium.

Additionally, the present disclosure may be realized by transmitting the computer program or digital signal via a telecommunication line, a wireless or wired communication line, a network such as the Internet, a data broadcast, or the like.

The present disclosure may also be a computer system including a microprocessor and memory, where the memory stores the above-described computer program and the microprocessor operates in accordance with the computer program.

The present disclosure may also be implemented by another independent computer system, by recording the program or the digital signal in the recording medium and transferring the recording medium, or by transferring the program or the digital signal over the network or the like.

The above-described embodiments and variations may be combined as well.

### INDUSTRIAL APPLICABILITY

The present disclosure can be used in data trading methods, terminals, and programs, and can be used in data trading methods, terminals, and programs capable of efficiently determining an appropriate trading price.

1. A data management method using a management system that includes a plurality of servers holding a distributed ledger,
wherein the plurality of servers store, in the distributed ledger, at least one instance of transaction data each including record information,
each of at least one instance of the record information included in a corresponding one of the at least one instance of transaction data includes a record of a data set, indicated by the record information,
each of at least one data set corresponding to one of the at least one instance of record information includes at least one instance of data, among a plurality of instances of data generated by a plurality of devices, that satisfies a condition corresponding to the data set, and
the data management method comprises performing the following, by one terminal among a first terminal owned by a first user of a target data set, among the at least one data set, and a second terminal owned by a second user of the target data set:
obtaining, from the at least one instance of record information stored in the distributed ledger, a record of at least one similar data set similar to the target data set; and
determining a value of the target data set based on the record of the at least one similar data set obtained.

2. The data management method according to claim 1,
wherein a plurality of instances of target data included in the target data set are specified from the plurality of instances of data using a first condition,
each of the at least one similar data set includes a plurality of instances of second data that satisfy a second condition, among the plurality of instances of data, and
the second condition is similar to the first condition.

3. The data management method according to claim 1, further comprising:
generating, by the one terminal, the transaction data including the record information that includes the record of the target data set, after a trade of the target data set is established;
transmitting, by the one terminal, the transaction data to at least one of the plurality of servers; and
storing the transaction data received by the at least one of the plurality of servers in the distributed ledger by the plurality of servers executing a consensus algorithm.

4. The data management method according to claim 1,
wherein the determining includes determining the value of the target data set based on the value of one similar data set among the at least one similar data set.

5. The data management method according to claim 4,
wherein the one similar data set is a newest similar data set among the at least one similar data set.

6. The data management method according to claim 4,
wherein the determining includes setting the value of the target data set higher as a total number of the at least one similar data set increases.

7. The data management method according to claim 4,
wherein the determining includes setting a higher value for the value of the target data set as a number by which the at least one similar data set increases per unit of time increases.

8. The data management method according to claim 1,
wherein the determining further includes:
determining a first value range for determining the value of the target data set, the first value range being acceptable to an owner of the one terminal;
obtaining a second value range for determining the value of the target data set from an other terminal among the first terminal and the second terminal, the second value range being acceptable to an owner of the other terminal;
specifying an overlapping value range where the first value range and the second value range overlap; and
determining a value included in the overlapping value range as the value of the target data set.

9. The data management method according to claim 8,
wherein the determining of the value includes determining a median value of the overlapping value range as the value of the target data set.

10. A terminal communicably connected over a network to a management system including a plurality of servers holding a distributed ledger,
wherein the plurality of servers store, in the distributed ledger, at least one instance of transaction data each including record information,
each of at least one instance of the record information included in a corresponding one of the at least one instance of transaction data includes a record of a data set, indicated by the record information,
each of at least one data set corresponding to one of the at least one instance of record information includes a plurality of instances of first data, among a plurality of instances of data generated by a plurality of devices, that satisfy a first condition corresponding to the data set, and
the terminal is one terminal among a first terminal owned by a first user of a target data set, among the at least one data set, and a second terminal owned by a second user of the target data set, and comprises:
an obtainer that obtains, from the at least one instance of record information stored in the distributed ledger, a record of at least one similar data set similar to the target data set; and
a determiner that determines a value of the target data set based on the record of the at least one similar data set obtained.

11. A non-transitory computer-readable recording medium having recorded thereon a program for causing a computer to execute a data management method using a management system that includes a plurality of servers holding a distributed ledger,
wherein the plurality of servers store, in the distributed ledger, at least one instance of transaction data each including record information,
each of at least one instance of the record information included in a corresponding one of the at least one instance of transaction data includes a record of a data set, indicated by the record information,
each of at least one data set corresponding to one of the at least one instance of record information includes a plurality of instances of first data, among a plurality of instances of data generated by a plurality of devices, that satisfy a first condition corresponding to the data set, and
the data management method comprises performing the following, by one terminal among a first terminal owned by a first user of a target data set, among the at least one data set, and a second terminal owned by a second user of the target data set:
obtaining, from the at least one instance of record information stored in the distributed ledger, a record of at least one similar data set similar to the target data set; and
determining a value of the target data set based on the record of the at least one similar data set obtained.
